(19) United States
(12) Patent Application Publication
(10) Pub. No.: US 2007/0285923 A1
(43) Pub. Date: Dec. 13, 2007

(54) Shining device for indication purpose

(76) Inventors: Hsin-Chin Chen, Taipei (TW); Hung-Pin Kuo, Sigang Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/448,084

(22) Filed: Jun. 7, 2006

(51) Int. Cl. F21S 6/00

(52) U.S. Cl. 362/257

(57) ABSTRACT

A shining device includes a high-power light emitting diode (LED) set, a grate plate, and a converging lens set; the grate plate is positioned in front of the LED set, and it has a light passage hole; the converging lens set is positioned in front of the grate plate; light emitted from the LED set will travel through the light passage hole of the grate plate, and will be convergent to become beams by means of the converging lens set, which beams will make a lighted area show on an object when traveling onto the object.

### BACKGROUND OF THE INVENTION

1. Field of the Invention

The present invention relates to a shining device for indication purpose, more particularly one, which is equipped with light emitting diodes (LEDs), a grate plate with a light passage hole, and a converging lens set; light emitted from the LEDs will travel through the light passage hole, and will be convergent to become beams by the converging lens set, which beams will make a lighted area show on an object for indicating when traveling onto the object.

2. Brief Description of the Prior Art

Indicating devices are used in briefing, and optical level gauges, and optical correcting devices are used in construction, which all can emit light beams. Most of such shining devices emit red light beams, which have relatively a long wavelength, and will be less bright when there is bright illumination in the environment. Therefore, the users are changing to shining devices capable of emitting green light beams, which have a shorter wavelength, and are brighter than red light beams.

Referring to FIG. 6, a green light-emitting device includes a red laser emitting diode 20, a lens set 21, a nonlinear optical frequency converting transistor 22, a filter lens 23, a photo conducting and sensing lens set 26. In use, the red laser emitting diode 20 emits red beams, the lens set 21 enlarge and reduce the dispersion angle of the beams, and the nonlinear optical frequency converting transistor 22 cause change in the optical frequency of the beams so as to produce laser light of different wavelengths and frequencies. Next, light is filtered by means of the filter lens 23 with some portions traveling to the photo conducting and sensing device 24 for the photo conducting and sensing device 24 to detect photo power and give the detected values to the automatic power circuit 25; thus, the red laser emitting diode 20 is controlled so as to emit beams of desired wavelengths. And, stable beams travel through the gathering and focusing lens set 26 such that they focus at an infinite distance, and will form a shining point on an object when traveling onto the object. Consequently, the beams can be used for indicating, distance measurement, and aiming. Furthermore, a line-forming lens 27 is positioned in front of the gathering and focusing lens set 26 for making the beams change shape such that a straight line-shaped lighted area, lighted areas in the shaped of two parallel lines or a cross-shaped lighted area will show on an object when the beams travel onto the object. Consequently, the beams can be used for indicating, marking, and measurement

Consisting of the red laser emitting diode 20 for emitting beams, the lens set 21 for focusing the beams, the nonlinear optical frequency converting transistor 22 for causing change in the optical frequency of the beams, the filter lens 23 for filtering the laser light, the photo conducting and sensing device 24 for detecting photo power, and the automatic power circuit 25 for controlling the red laser emitting diode 20, the above green light-emitting device has a relatively complicated structure, and high component and assembly cost. Furthermore, there would be phenomenon of power becoming unstable in wavelength conversion. Consequently, performance of the green light-emitting device is badly affected.

### SUMMARY OF THE INVENTION

It is a main object of the invention to provide an improvement on a shining device to overcome the above-mentioned problems. The shining device of the present invention includes a high-power light emitting diodes (LED) set, a grate plate, and a converging lens set; the LED set can be a single-color one or a multi-color one consisting of different-color LEDs, e.g. red, green, and blue ones. The grate plate is positioned in front of the LED set, and it has a light passage hole. The converging lens set is positioned in front of the grate plate. Thus, light emitted from the LED set will travel through the light passage hole of the grate plate, and will be convergent to become beams by means of the converging lens set, which beams will make a lighted area show on an object when traveling onto the object.

In addition, the light passage hole of the grate plate has a geometric shape, e.g. a straight line, parallel lines, and a cross, and the light emitting diodes are arranged in an array according to the shape of the light passage hole. Therefore, there will be a straight line-shaped, a cross-shaped or parallel line-shaped lighted area showing on an object when the beams from the shining device travels onto the object through the converging lens set.

### BRIEF DESCRIPTION OF THE DRAWINGS

The present invention will be better understood by referring to the accompanying drawings, wherein:

FIG. 1 is a sectional view of the present invention in use,

FIG. 2 is a geometric view of the grate plate in the invention,

FIG. 3 is a view of a preferred embodiment of the grate plate,

FIG. 4 is a view of another preferred embodiment of the grate plate,

FIG. 5 is a view of yet another preferred embodiment of the grate plate, and

FIG. 6 is a sectional view of the prior art in use.

### DETAILED DESCRIPTION OF THE PREFERRED EMBODIMENTS

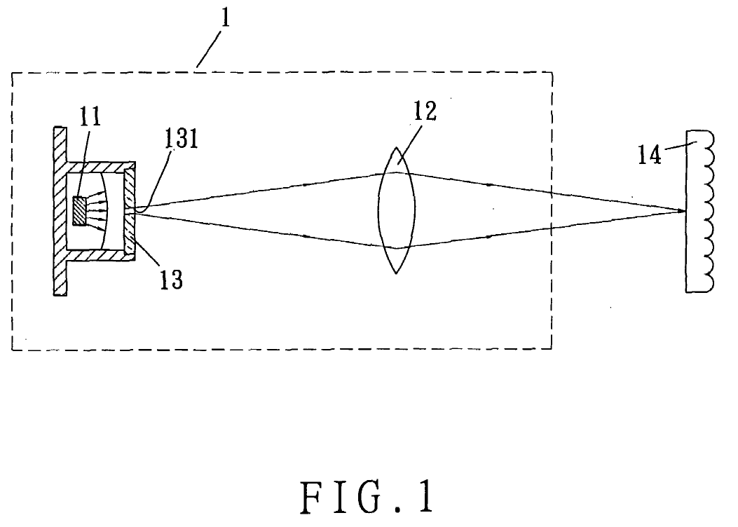

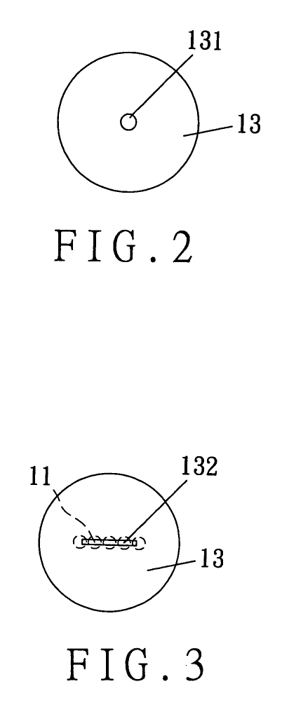

FIGS. 1 and 2 shows a preferred embodiment of a shining device 1 for indication purpose in the present invention, which includes a high-power light emitting diode (LED) set 11, a converging lens set 12, and a grate plate 13. The LED set 11 can be a single-color one or a multi-color one consisting of different-color LEDs, e.g. red, green, and blue ones. The grate plate 13 is positioned in front of the LED set 11, and the converging lens set 12 is positioned in front of the grate plate 13. The grate plate 13 has a light passage hole 131 thereon, which can be round, triangular, square or other geometric shapes; thus, light emitted from the LED set 11 will become a beam when traveling through the light passage hole 131 of the grate plate 13. And, the beam will pass through and be converged by means of the converging lens set 12 such that it will form a shining point on an object when traveling onto the object. Furthermore, a circuit can be connected to the LED set 11 for controlling the LED set 11 so that the LED set 11 emit light of desired colors.

In use, the LED set 11 emit light, and the light passes through the light passage hole 131 of the grate plate 13 to become a beam with a geometric shape, and the beam passes through and is converged by means of the converging lens set 12; thus, the beam will form a shining point on an object for indicating the object when traveling onto the object. Furthermore, a line-forming lens 14 is positioned in front of the converging lens set 12 for changing the shape of the beam such that the beam will form a shining straight line on an object for indicating the object when traveling onto the object. Thus, the shining device can be used as a line marking device, an optical level gauges or an indicator.

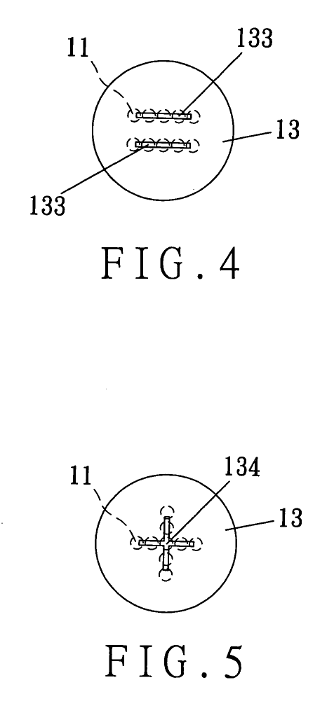

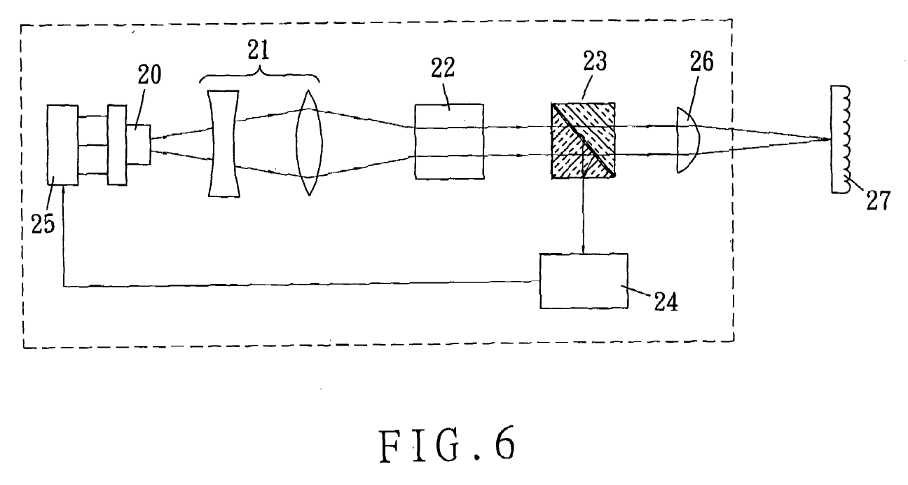

Referring to FIGS. 1 to 5, the light passage hole of the grate plate 13 has a geometric shape, and LEDs in the set 11 are arranged in an array according to the shape of the light passage hole of the grate plate 13. Referring to FIG. 3, the grate plate 13 has a straight-line shaped passage hole 132 instead; thus, there will be a straight line-shaped lighted area on an object when the beam from the shining device travels onto the object through the converging lens set 12. Referring to FIG. 4, the grate plate 13 has passage holes 133 in the shape of two parallel lines instead; thus, there will be lighted areas in the shape of two parallel lines on an object when the beam from the shining device travels onto the object through the converging lens set 12. Referring to FIG. 5, the grate plate 13 has a cross-shaped passage hole 134 instead; thus, there will be a cross-shaped lighted area on an object when the beam from the shining device travels onto the object through the converging lens set 12. Consequently, the beam emitted from the shining device can be used for indicating, marking, and aiming.

From the above description, it can be seen that the present invention has the following advantages over the prior art described in Background:

1. The present invention only consists of the light emitting diode (LED) set, the converging lens set, and the grate plate therefore it has a simpler structure than the prior art.

2. The present invention has lower component and assembly cost than the prior art. Therefore, the present invention is more economical to use.

3. The present invention has more stable output power because LEDs are used as the power source in the present invention while laser diodes are used as the power source in the prior art. And, there is no wavelength conversion, and power won't become unstable in the present invention.

4. The LEDs of the shining device of the present invention are arranged in an array according to the shape of the light passage hole of the grate plate therefore the beam emitted from the shining device has very high brightness.

What is claimed is:

1. A shining device for indication purpose, comprising
a light emitting diode set,
a grate plate positioned in front of the LED set, the grate plate having a light passage hole; and
a converging lens set positioned in front of the grate plate;
whereby light emitted from the LED set will travel through the light passage hole of the grate plate, and will be convergent to become beams by means of the converging lens set, which beams will make a lighted area show on an object when traveling onto the object.
